(19) United States
(12) Patent Application Publication
(10) Pub. No.: US 2021/0313718 A1
(43) Pub. Date: Oct. 7, 2021

(54) CONNECTOR ASSEMBLY HAVING LOW PROFILE

(71) Applicant: 3M INNOVATIVE PROPERTIES COMPANY, St. Paul, MN (US)

(72) Inventors: Chin Hua Lim, Singapore (SG); Kok Hoe Lee, Singapore (SG); Saujit Bandhu, Singapore (SG); YunLong Qiao, Singapore (SG); Rao L. Vittapalli, Singapore (SG)

(21) Appl. No.: 17/250,830

(22) PCT Filed: Sep. 30, 2019
(86) PCT No.: PCT/IB2019/058293

§ 371 Date: Mar. 9, 2021

Related U.S. Application Data
(60) Provisional application No. 62/743,150, filed on Oct. 9, 2018.

(51) Int. Cl. H01R 12/62; H01R 12/71; H01R 12/72; H01R 13/504; H01R 13/627

(52) U.S. Cl. CPC H01R 12/62; H01R 12/714; H01R 13/6275; H01R 13/504; H01R 12/721

(57) ABSTRACT

A connector assembly includes a circuit board that includes conductive front pads conductive rear pads, a cable terminated at the rear pads, and a unitary front housing assembled to the front end the circuit board. The connector assembly also includes flexible contacts assembled to the unitary front housing. The front pads make contact with and deflect the flexible contacts away from the circuit board. The connector assembly also includes a conductive shield assembled to the unitary front housing, and a unitary rear housing tightly overmolded around at least the circuit board and portions of the unitary front housing, the cable, and the shield.

### TECHNICAL FIELD

The disclosure generally relates to a connector assembly and its construction.

### BACKGROUND

Cable assembly plug connectors of different interfaces such as miniSAS and PCIe, or receptacle connectors, require miniaturized, high speed interconnect systems with smaller form factor. As interconnect systems progress toward miniaturization and higher signal speed, the system components are required to be, in parallel, designed to comply with these requirements. Interconnect assembly designs become more complex and intricate, and therefore require optimization to increase efficiency of the product design.

### SUMMARY

Various aspects and embodiments described herein relate to a connector assembly with reduced terminal array pitch, minimized components count, and exhibiting high signal speed without compromising the signal integrity impedance matching.

An aspect of the present disclosure relates to a connector assembly including a circuit board having an upper surface and an opposing lower surface, a front end and a cable end opposite the front end. A plurality of conductive front pads are disposed on the upper and lower surfaces at the front end. A plurality of conductive rear pads are disposed on the upper and lower surfaces at the cable end and electrically connected to the front pads. At least one cable includes a plurality of conductors. The front ends of the conductors terminate at the rear pads. A unitary front housing includes a mating end and an opposing board end proximate the front end of the circuit board. The unitary front housing has an opposing major top and bottom surfaces defining a central slot therein extends along a mating direction of the connector assembly from the mating end to the board end of the front housing. The central slot includes opposing top and bottom surfaces facing each other. The unitary front housing includes opposing top and bottom rows of alternating ridges and valleys formed on each of the major top and bottom surfaces of the front housing proximate the board end of the front housing. The unitary front housing further includes opposing supports at opposing ends of the rows of alternating ridges and valleys. A plurality of contacts are disposed on the opposing top and bottom surfaces of the central slot. Each contact has a flexible contact member exposed to the central slot for making contact with a corresponding contact of a mating connector, a retaining member extends from the flexible contact member and is secured in a corresponding valley in the opposing top and bottom rows of alternating ridges and valleys, and a flexible termination member extends rearwardly from the contact member and makes electrical contact with a corresponding front pad of the circuit board. A unitary rear housing is tightly overmolded around at least the circuit board, the termination and retaining members of the contacts, and the front ends of the conductors.

Another aspect of the disclosure relates to a connector assembly including a circuit board having a plurality of conductive front pads disposed at a front end of the circuit board and a plurality of conductive rear pads disposed at an opposite cable end of the circuit board. A cable terminates at the plurality of the rear pads. A unitary front housing is assembled to the front end the circuit board. A plurality of flexible contacts are assembled to the unitary front housing, the front pads makes contact with and deflects the flexible contacts away from the circuit board. An electrically conductive shield is assembled to the unitary front housing. A unitary rear housing is tightly overmolded around at least the circuit board and portions of the unitary front housing, the cable, and the shield.

Some embodiments relate to an electrical contact for use in an electrical connector assembled to a circuit board. The electrical contact includes a flexible contact member extending along a first direction for making contact with a corresponding contact of a mating connector. The flexible contact member has opposing front and rear ends. A retaining member includes a first retaining member portion extending rearwardly from the rear end of the flexible contact member along the first direction. The retaining member further includes a second retaining member portion extending upwardly from a rear end of the first retaining member portion along a second direction orthogonal to the first direction. The retaining member further includes a third retaining member portion extending from a top end of the second retaining member portion along the first direction toward the front end of the flexible contact member. A flexible termination member extends rearwardly from the rear end of the flexible contact member, such that when the contact is assembled to a connector and the connector is assembled to a circuit board, the flexible termination member makes electrical contact with a pad of the circuit board.

These and other aspects of the present application will be apparent from the detailed description below. In no event, however, should the above summaries be construed as limitations on the claimed subject matter, which subject matter is defined solely by the attached claims.

### BRIEF DESCRIPTION OF DRAWINGS

The various aspects of the disclosure will be discussed in greater detail with reference to the accompanying figures where,

FIG. 1 schematically shows a connector assembly according to an embodiment;

FIG. 2A-2B schematically show a circuit board assembled with plurality of electrical contacts and cable conductors;

FIG. 3A-3B and 4A-4B schematically show different views of a unitary front housing;

FIG. 5 shows a pair of electrical contacts for use in an electrical connector assembled to a circuit board;

FIG. 6A shows a partial cross section of the connector assembly disconnected from a mating connector;

FIG. 6B shows a partial cross section of the connector assembly connected with a mating connector;

FIG. 7A-7B show exploded and schematic views of a latching member to be assembled with the unitary front housing;

FIG. 8A-8B show details of assembly of the latching member with the front unitary housing;

FIG. 9 shows an exploded view of the connector assembly according to an aspect of the disclosure;

FIG. 10 shows the bottom view of the connector assembly;

FIG. 11 schematically shows the connector assembly latched to an electrically conductive shield assembled to the unitary front housing according to an embodiment;

FIG. 12 shows an exploded view of a portion of the latching member and the unitary rear housing according to an aspect; and

FIG. 13 shows a partial cross section of the connector assembly.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION OF ILLUSTRATIVE EMBODIMENTS

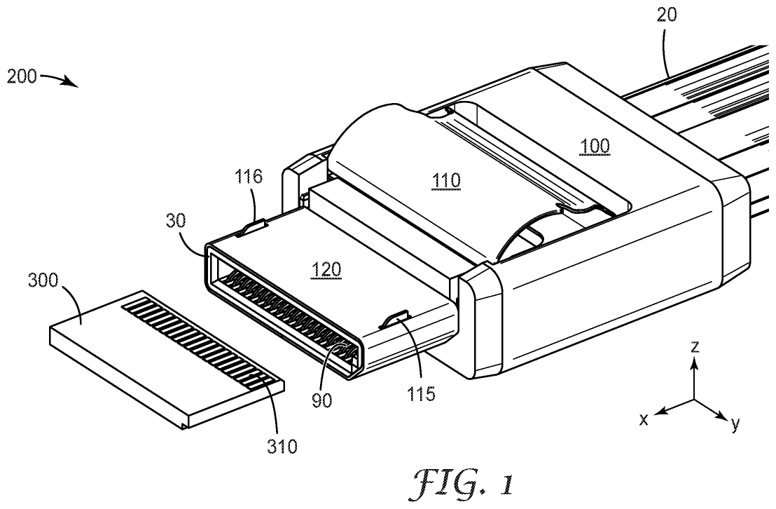

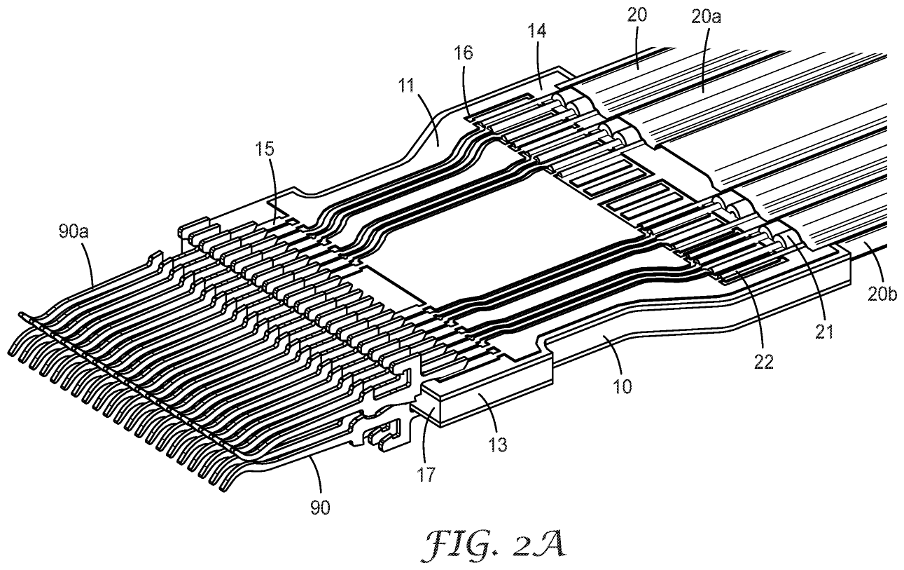

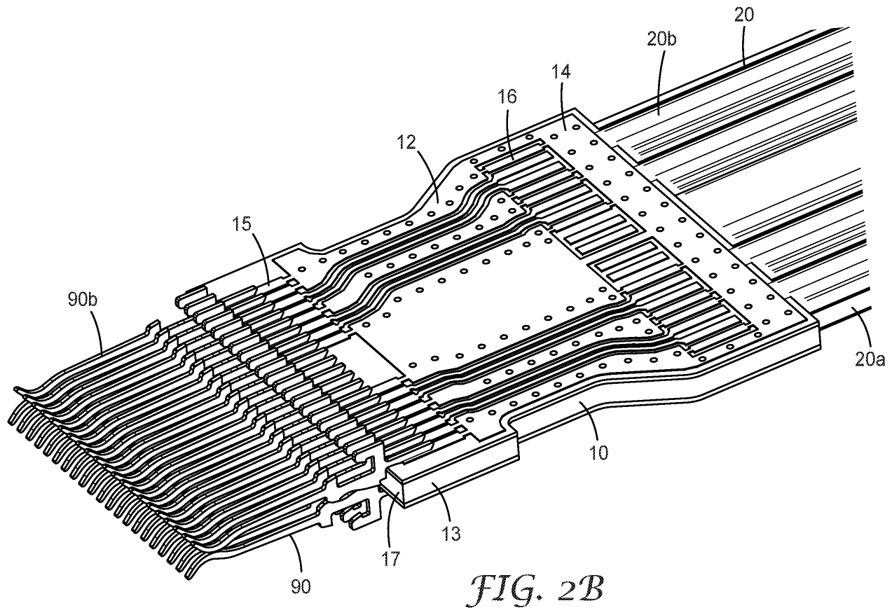

As illustrated in FIGS. 1 and 2A-2B, a connector assembly (200) according to an embodiment includes a circuit board (10) having a plurality of conductive front pads (15) disposed at a front end (13) of the circuit board, and a plurality of conductive rear pads (16) disposed at a cable end (14) of the circuit board opposite the front end (13). The connector assembly includes at least one cable (20) terminating at the plurality of the rear pads (16). A unitary front housing (30) is assembled to the front end (13) the circuit board and a plurality of flexible contacts (90) is assembled to the unitary front housing (30). The front pads (15) of the circuit board (10) make contact with and deflect the flexible contacts (90) away from the circuit board (10). An electrically conductive shield (120) is assembled to the unitary front housing (30). A unitary rear housing (100) is tightly overmolded around at least the circuit board (10) and portions of the unitary front housing (30), the cable (20), and the shield (120).

The circuit board (10) has an upper surface (11) and an opposing lower surface (12). The plurality of conductive front pads (15) are disposed on the upper and lower surfaces (11, 12) at the front end (13). The plurality of conductive rear pads (16) are disposed on the upper and lower surfaces (11, 12) at the cable end (14) and are electrically connected to the front pads (15). The cable (20) has a plurality of conductors (21) where front ends (22) of the conductors (21) terminate at the rear pads (16). In certain aspects, the at least one cable includes an upper cable (20a) terminating at the rear pads (16) of the circuit board (10) disposed on the upper surface (11) of the circuit board, and a lower cable (20b) terminating at the rear pads (16) of the circuit board disposed on the lower surface (12) of the circuit board.

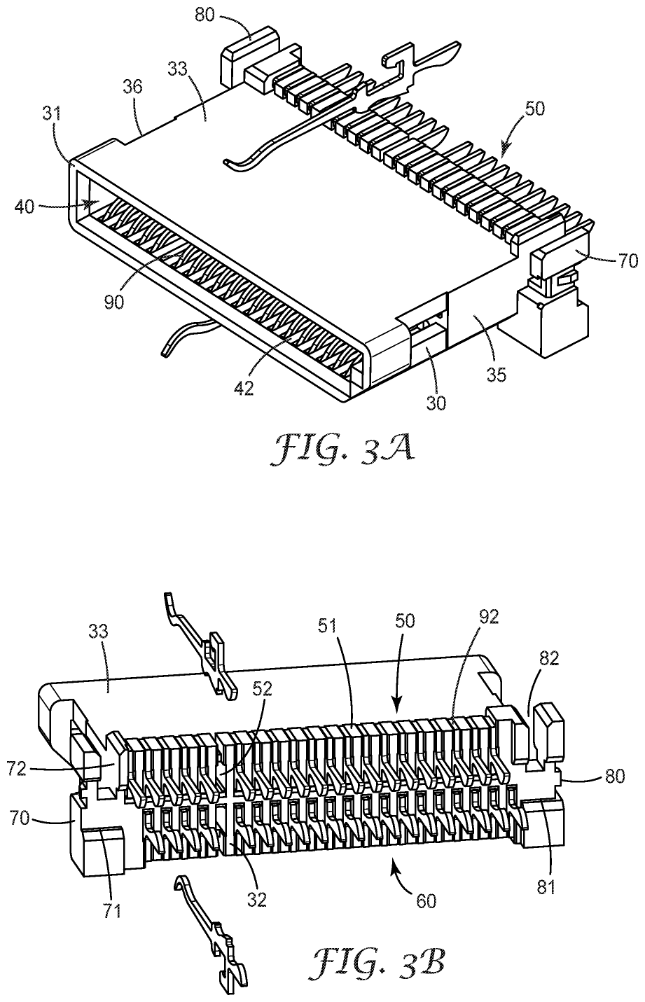

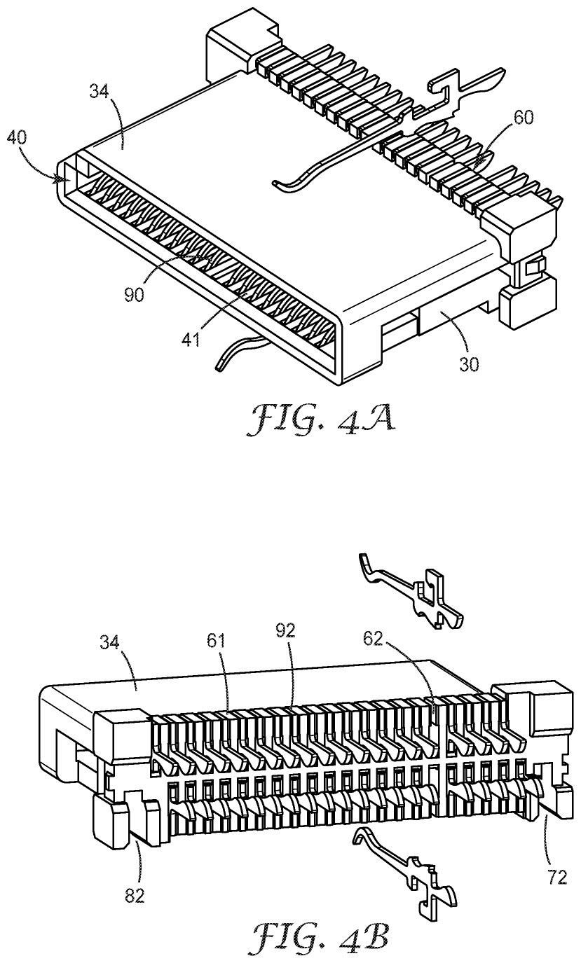

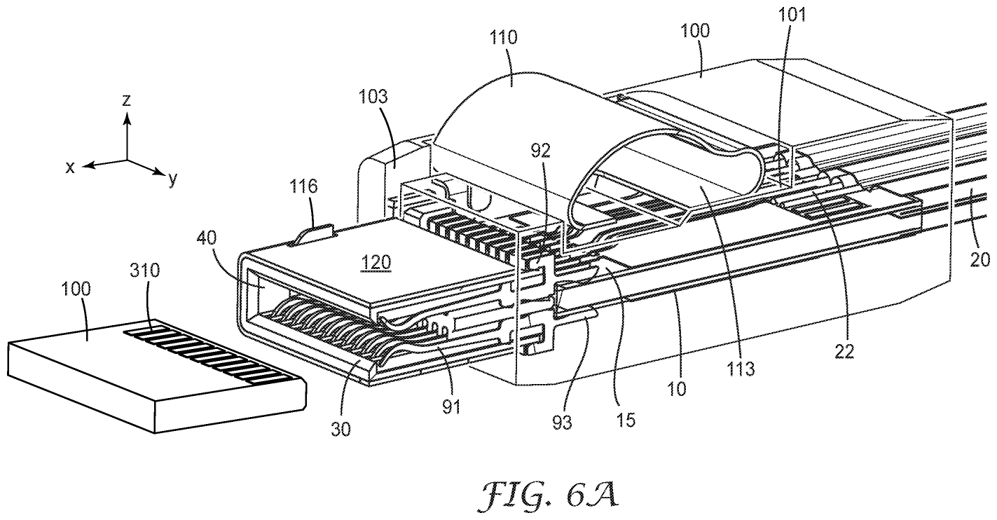

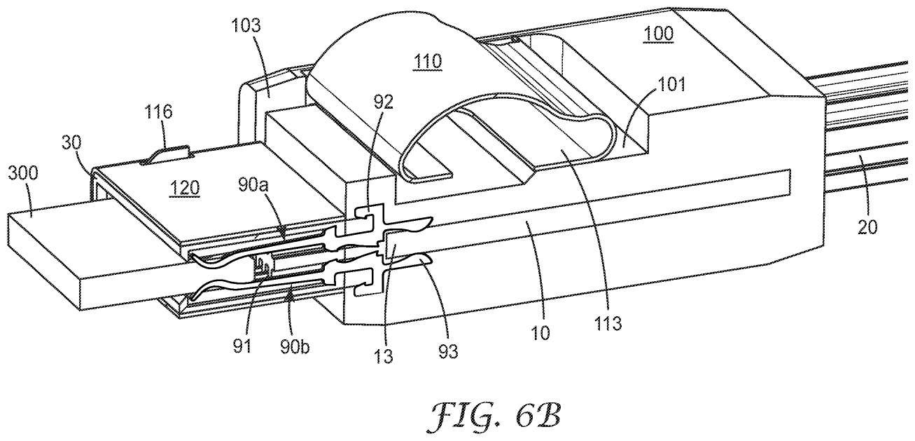

The unitary front housing (30) as shown in FIG. 3A-3B and 4A-4B includes a mating end (31) and an opposing board end (32) proximate the front end (13) of the circuit board. The front housing has a major top surface (33) and an opposing bottom surface (34). The front housing further includes opposing minor side surfaces (35, 36) connecting the major top and bottom surfaces (33, 34) of the front housing (30). The opposing major top and bottom surfaces (33, 34) of the unitary front housing (30) define a central slot (40) therein extending along a mating direction (x-direction, referring to the illustrated x-y-z coordinate system) of the connector assembly from the mating end (31) to the board end (32) of the front housing (30). The central slot (40) has a top surface (41) and an opposing bottom surface (42) facing each other. The plurality of contacts (90) are disposed on the opposing top and bottom surfaces (41, 42) of the central slot (40). In certain embodiments, the plurality of contacts (90) includes a plurality of upper contacts (90a) disposed on the top surface (41) of the central slot (40), and a plurality of lower contacts (90b) disposed on the bottom surface (42) of the central slot. During assembly of the unitary front housing (30) with the circuit board, the front end (13) of the circuit board (10) deflects the pluralities of upper and lower contacts (90a, 90b) away from each other as can be seen in FIG. 6A and 6B.

The front housing (30) includes opposing top and bottom rows (50, 60) of alternating ridges (51, 61) and valleys (52, 62). These rows of ridges and valleys are formed on each of the major top and bottom surfaces (33, 34) of the front housing (30) proximate the board end (32) of the front housing. The front housing (30) further includes opposing supports (70, 80) at opposing ends of the rows of alternating ridges (51, 61) and valleys (52, 62). Each of the opposing supports (70, 80) includes a shoulder (71, 81) supporting a front edge (17) of the front end (13) of the circuit board (10). Each of the opposing supports (70, 80) further defines a first slot (72, 82) configured to receive an arm of opposing arms of a latching member of the connector assembly.

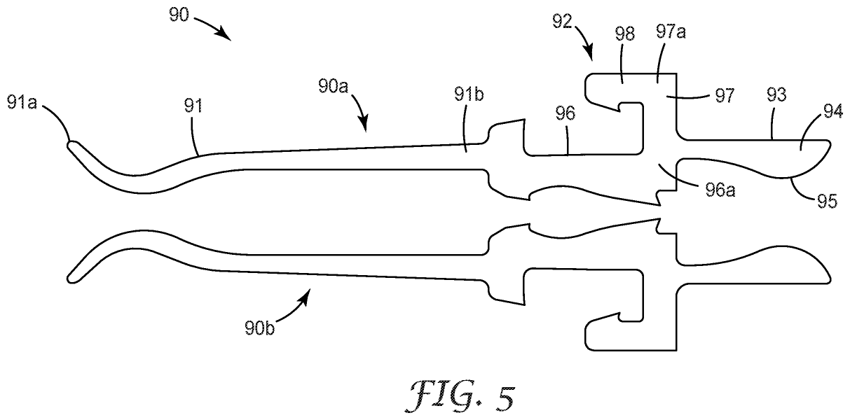

As best shown in FIGS. 5, 6A and 6B, each of the plurality of contacts (90) includes a flexible contact member (91), a retaining member (92), and a flexible termination member (93). In some embodiments, the electrical contact (90) is planar (for example, the electrical contact (90) may lie in the xz plane of FIG. 5). In some embodiments, the flexible contact member (91), the retaining member (92), and the flexible termination member (93) lie in the same plane (e.g., the xz plane of FIG. 5). The flexible contact member (91) is exposed to the central slot (40) for making contact with a corresponding contact (310) of a mating connector (300). The retaining member (92) extends from the flexible contact member (91) and is secured in a corresponding valley (52, 62) in the opposing top and bottom rows of alternating ridges and valleys as can best be seen in FIGS. 3B and 4B. The flexible termination member (93) extends rearwardly from the contact member (91) to make electrical contact with a corresponding front pad (15) of the circuit board (10). In some embodiments, the flexible termination member (93) of each contact makes solderless physical and electrical contact with the corresponding front pad (15) of the circuit board (10). In some other embodiments, the flexible termination member (93) of each contact is soldered to the corresponding front pad (15) of the circuit board (10). In certain aspects, the flexible termination member (93) of each contact (90) is deflected or flexed by the front pad (15) of the circuit board (10) corresponding to the flexible termination member (93). The deflection of the flexible termination member (93) by the front pad (15) occurs in a direction (z) away from the front pad (15). In certain aspects, the flexible termination member (93) includes a disc portion (94) having a peripheral edge (95) that makes electrical contact with a corresponding front pad (15) of the circuit board (10). The peripheral edge (95) is a curved peripheral edge (95), such that when the contact (90) is assembled to the connector and the connector is assembled to the circuit board (10), the curved peripheral edge (95) makes solderless physical and electrical contact with, and is deflected by, the pad (15) of the circuit board (10).

The flexible contact member (91) extends along a first direction (x) for making contact with a corresponding contact (310) of a mating connector (300). The flexible contact member (91) includes a front end (91a) and an opposing rear end (91b). The retaining member (92) includes a first retaining member portion (96), a second retaining member portion (97), and a third retaining member portion (98). The first retaining member portion (96) extends rearwardly from the rear end (91b) of the flexible contact member (91) along the first direction (x). The second retaining member portion (97) extends upwardly from a rear end (96a) of the first retaining member portion (96) along a second direction (z) orthogonal to the first direction (x). The third retaining member portion (98) extends from a top end (97a) of the second retaining member portion (97) along the first direction (x) toward the front end (91a) of the flexible contact member (91). The flexible termination member (93) extends rearwardly from the rear end (91b) of the flexible contact member (91), such that when the contact (90) is assembled to a connector and the connector is assembled to a circuit board (10), the flexible termination member (93) makes electrical contact with a pad (15) of the circuit board (10).

In certain embodiments, and as shown in FIGS. 6A and 6B, the unitary rear housing (100) is tightly overmolded around at least the circuit board (10), the retaining and terminating members (92, 93) of the contacts (90), and the front ends (22) of the conductors (21). In certain aspects, the circuit board (10) is fully enclosed within the unitary rear housing (100).

In some embodiments, the overmolding of the unitary rear housing (100) is done by one or more of injection molding, compression molding, blow molding, extrusion and casting. In certain embodiments, the unitary front housing is made of plastic.

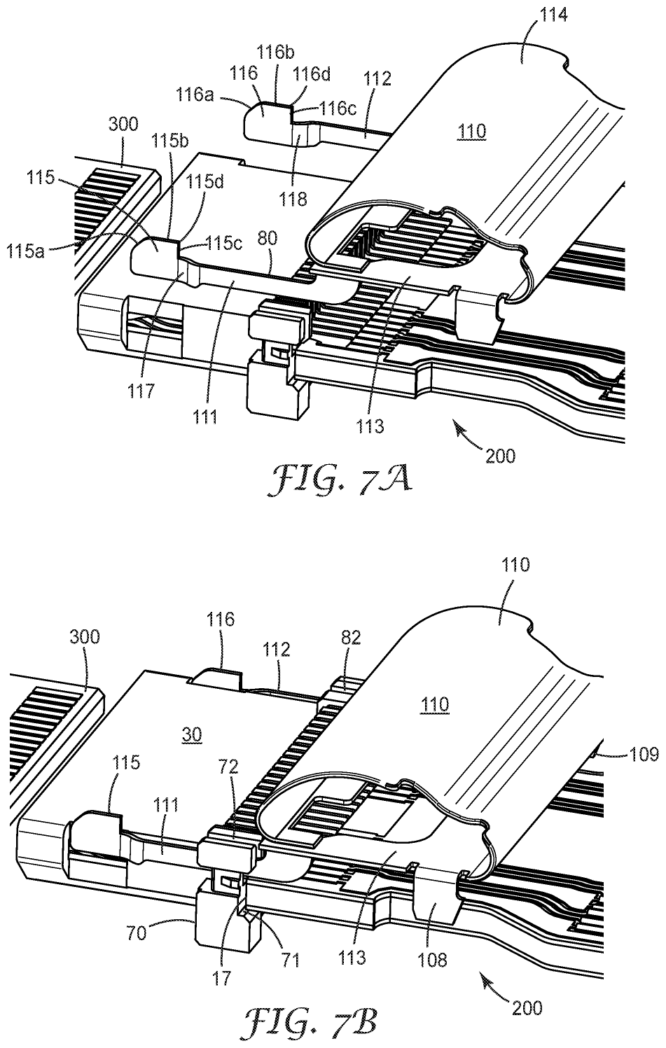

As shown in FIGS. 6A and 6B, the connector assembly includes a latching member (110) assembled to the unitary front housing (30) and rear housing (100) for latching the connector assembly (200) to a mating conductor (300). In certain aspects, the latching member (110) is removably assembled to unitary front housing (30) and/or the rear housing (100). The latching member (110) includes a bottom portion (113) resting on a major top surface (101) of the unitary rear housing (100). Opposing arms (111, 112) of the latching member (110) extending forwardly from the bottom portion (113). In certain embodiments, each arm (111, 112) of the latching member (110) is disposed adjacent, and extends forwardly along, a corresponding minor side (35, 36) surface of the front housing (30). Each of the opposing arms (111, 112) is received in a corresponding first slot (72, 82) of the opposing supports (70, 80) as shown in FIGS. 7A and 7B. The arm (111, 112) is capable of moving up and down within the first slot (72, 82) for latching and unlatching the connector assembly to a mating connector (300). The latching member further includes a top potion (114) opposite the bottom portion (113), such that pressing the top portion moves the opposing arms (111, 112) within the first slots (72, 82) for unlatching the connector assembly (200) from the mating connector (300).

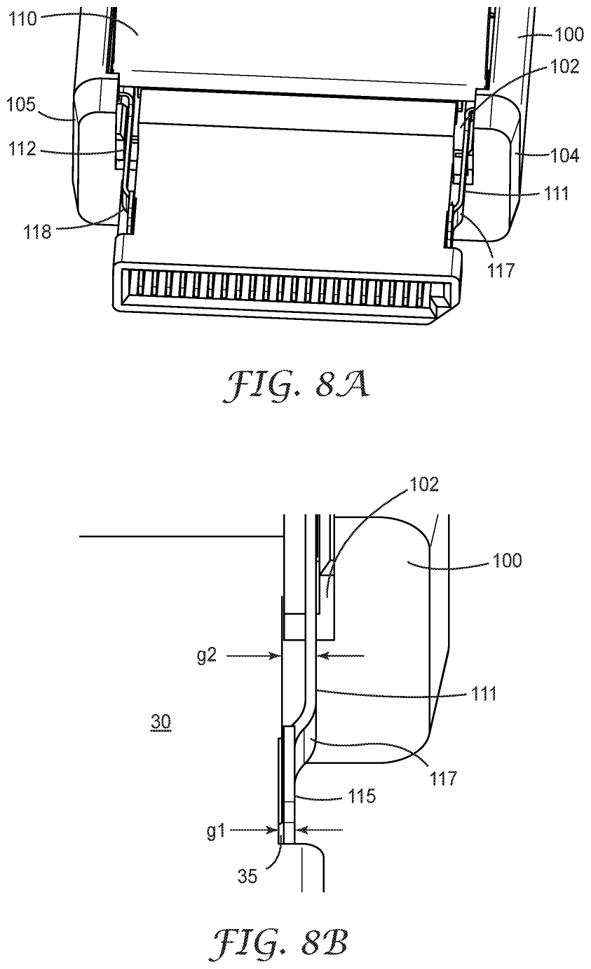

In certain aspects, each arm (111, 112) of the latching member (110) terminates in a latch (115, 116) for latching to a mating connector (300). The latches (115, 116) engage with corresponding openings (not shown) in the mating connector (300). Pressing the top portion (114) moves the opposing arms (111, 112) within the first slots (72, 82) for unlatching the connector assembly (200) from the mating connector (300), and releasing the pressing force on the top portion returns the latch member to its original position. An elbow (117, 118) joins the latch (115, 116) to the arm (111, 112). The elbow turns the arm (111, 112) toward the minor side surface (35, 36) corresponding to the arm, such that a gap (g1) between the latch (115) and the side surface (35) is less than a gap (g2) between the arm (111) and the side surface as can be best seen in FIGS. 8A and 8B.

In some aspects, each of the latches (115, 116) has a first portion (115a, 116a) with a chamfered top edge, a second portion (115b, 116b) extending rearwardly from the first portion (115a, 116a) and parallel to the respective opposing arms (111, 112), and a third portion (115c, 116c) extending downwardly from a rear end (115d, 116d) of the second portion (115b, 116b) up to an intersection of the elbow (117, 118) with the latches (115, 116). The chamfered top edge of the first portion (115a, 116a) allows unimpeded movement of the mating connector (300) until the corresponding openings (not shown) in the mating connector (300) engages with the downwardly extending third portion (115c, 116c) of the latches (115, 116) to latch the mating connector (300) with the connector assembly (200). Upon latching the mating connector is securely connected with the connector assembly (200) until unlatching occurs by pressing the top portion (114) of the latching member (110).

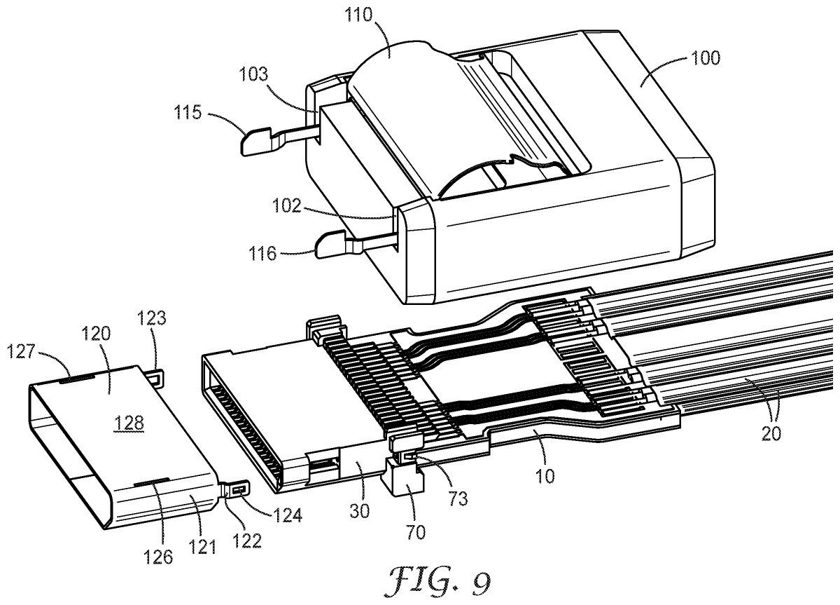

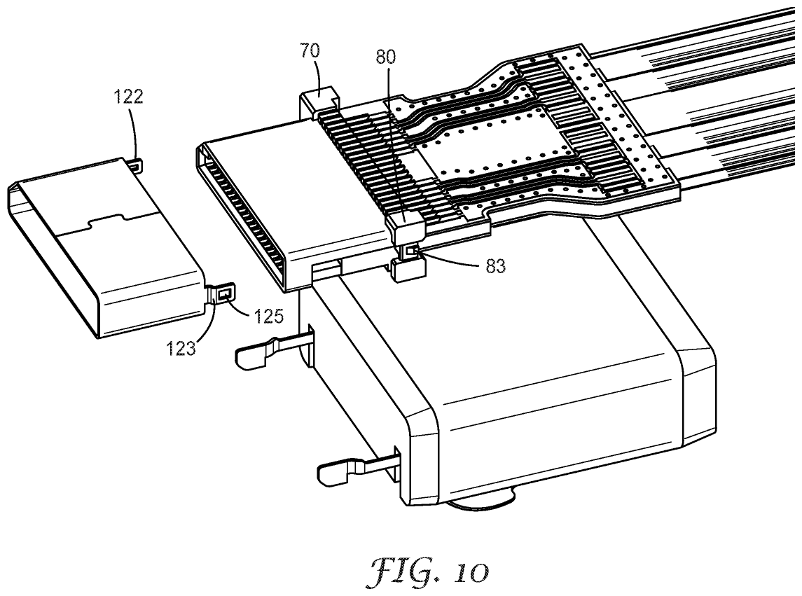

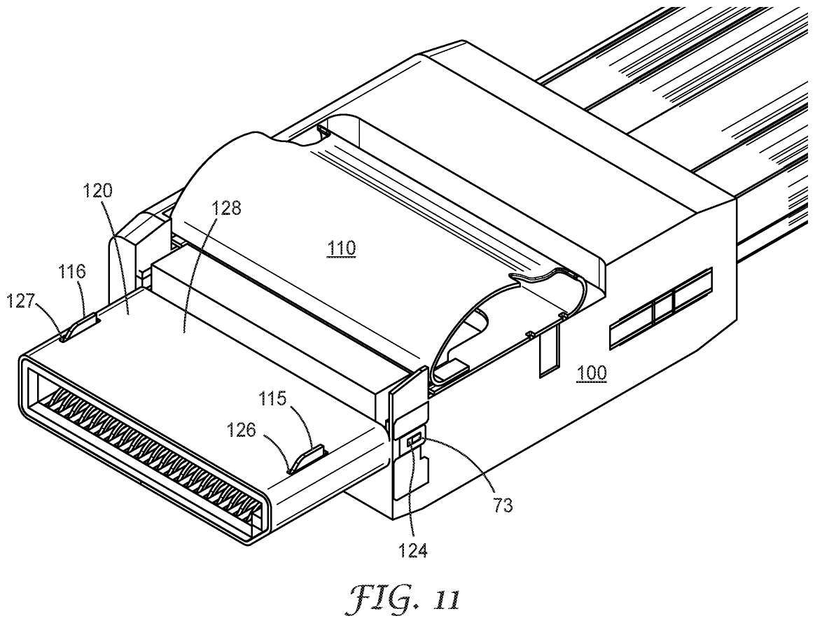

In another aspect of the connector assembly, the electrically conductive shield (120) is assembled to the unitary front housing (30). As shown in FIGS. 9 and 10, the shield (120) has opposing arms (122, 123) extending rearwardly from the shield (120) on lateral sides of the unitary front housing (30). Each arm (122, 123) of the shield defines an opening (124, 125) therein that engages a corresponding protrusion (73, 83) disposed on a lateral side of the corresponding support (70, 80) of the unitary front housing (30), as can best be seen in FIG. 11. In certain embodiments, the unitary rear housing (100) is tightly overmolded around at least rear end portion (121) of the shield (120).

According to an embodiment, each latch (115, 116) of the latching member (110) is disposed in and protrudes upwardly from a corresponding opening (126, 127) defined in a major top surface (128) of the shield (120).

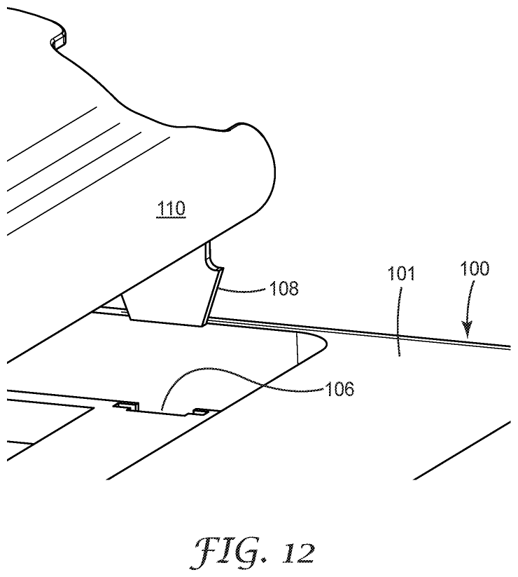

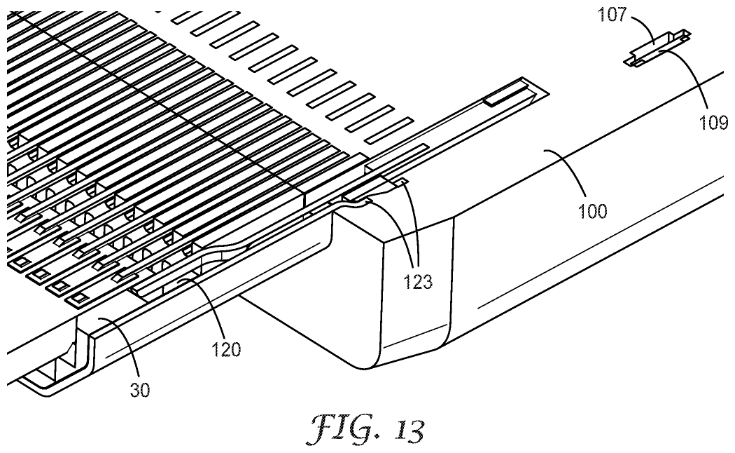

The unitary rear housing (100) defines opposing second slots (102, 103) formed in the major top surface (101), and near opposite lateral ends (104, 105), of the unitary rear housing (100), as can best be seen in FIG. 8A. Each arm (111, 112) of the latching member (110) is disposed in a corresponding second slot (102, 103). Further, as shown in FIG. 7B, opposing protrusions (108, 109) extend downwardly from the bottom portion (113) of the latching member (110). Each protrusion (108, 109) is disposed in a corresponding third slot (106, 107) formed in the major top surface (101) of the unitary rear housing (100), as exemplarily shown in FIGS. 12 and 13, to secure the latching member (110) with the rear housing (100).

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific Embodiments shown and described without departing from the scope of the present disclosure. This application is intended to cover any adaptations or variations of the specific Embodiments discussed herein. Therefore, it is intended that this disclosure be limited only by the claims and the equivalents thereof.

1. A connector assembly comprising:
a circuit board comprising:
an upper surface and an opposing lower surface;
a front end and a cable end opposite the front end;
a plurality of conductive front pads disposed on the upper and lower surfaces at the front end; and
a plurality of conductive rear pads disposed on the upper and lower surfaces at the cable end and electrically connected to the front pads;
at least one cable comprising a plurality of conductors, front ends of the conductors terminated at the rear pads;
a unitary front housing comprising a mating end and an opposing board end proximate the front end of the circuit board, and opposing major top and bottom surfaces and defining a central slot therein extending along a mating direction of the connector assembly from the mating end to the board end of the front housing, the central slot comprising opposing top and bottom surfaces facing each other, the unitary front housing comprising:
opposing top and bottom rows of alternating ridges and valleys formed on each of the major top and bottom surfaces of the front housing proximate the board end of the front housing; and
opposing supports at opposing ends of the rows of alternating ridges and valleys;
a plurality of contacts disposed on the opposing top and bottom surfaces of the central slot, each contact comprising:
a flexible contact member exposed to the central slot for making contact with a corresponding contact of a mating connector;
a retaining member extending from the flexible contact member and secured in a corresponding valley in the opposing top and bottom rows of alternating ridges and valleys; and
a flexible termination member extending rearwardly from the contact member and making electrical contact with a corresponding front pad of the circuit board; and
a unitary rear housing tightly overmolded around at least the circuit board, the termination and retaining members of the contacts, and the front ends of the conductors.

2. The connector assembly of claim 1, wherein the circuit board is fully enclosed within the unitary rear housing.

3. The connector assembly of claim 1, wherein each of the opposing supports defines a first slot therein, and wherein the connector assembly further comprises a latching member assembled to the unitary front housing and comprising:
a bottom portion resting on a major top surface of the unitary rear housing;
opposing arms extending forwardly from the bottom portion, each arm disposed within the first slot of a corresponding support in the opposing supports and configured to move up and down within the first slot; and
a top portion opposite the bottom portion, such that pressing the top portion moves the opposing arms within the first slots for unlatching the connector assembly from a mating connector.

4. The connector assembly of claim 1 further comprising an electrically conductive shield assembled to the unitary front housing, the unitary rear housing tightly overmolded around at least rear end portion of the shield.

5. The connector assembly of claim 1, wherein the flexible termination member of each contact is deflected by the front pad corresponding to the flexible termination member.

6. The connector assembly of claim 1, wherein the plurality of contacts comprises a plurality of upper contacts disposed on the top surface of the central slot, and a plurality of lower contacts disposed on the bottom surface of the central slot, such that when the unitary front housing is assembled to the front end of the circuit board, the front end of the circuit board deflects the pluralities of upper and lower contacts away from each other.

7. A connector assembly, comprising:
a circuit board comprising a plurality of conductive front pads disposed at a front end of the circuit board and a plurality of conductive rear pads disposed at an opposite cable end of the circuit board;
a cable terminated at the plurality of the rear pads; and
a unitary front housing assembled to the front end the circuit board;
a plurality of flexible contacts assembled to the unitary front housing, the front pads making contact with and deflecting the flexible contacts away from the circuit board;
an electrically conductive shield assembled to the unitary front housing; and
a unitary rear housing tightly overmolded around at least the circuit board and portions of the unitary front housing, the cable, and the shield.

8. An electrical contact for use in an electrical connector assembled to a circuit board, comprising:
a flexible contact member extending along a first direction for making contact with a corresponding contact of a mating connector, the flexible contact member comprising opposing front and rear ends;
a retaining member comprising:
a first retaining member portion extending rearwardly from the rear end of the flexible contact member along the first direction;
a second retaining member portion extending upwardly from a rear end of the first retaining member portion along a second direction orthogonal to the first direction; and
a third retaining member portion extending from a top end of the second retaining member portion along the first direction toward the front end of the flexible contact member; and
a flexible termination member extending rearwardly from the rear end of the flexible contact member, such that when the contact is assembled to a connector and the connector is assembled to a circuit board, the flexible termination member makes electrical contact with a pad of the circuit board.

9. The electrical contact of claim 8, wherein the flexible termination member comprises a disc portion comprising a curved peripheral edge, such that when the contact is assembled to the connector and the connector is assembled to the circuit board, the curved peripheral edge makes solderless physical and electrical contact with, and is deflected by, the pad of the circuit board.

10. The electrical contact of claim 8, wherein the flexible contact member, the retaining member, and the flexible termination member lie in a same plane.

11. The connector assembly of claim 1, wherein each of the opposing supports comprises a shoulder supporting a front edge of the front end of the circuit board.

12. The connector assembly of claim 1, wherein each of the opposing supports defines a first slot therein configured to receive an arm of opposing arms of a latching member of the connector assembly therein, such that when the latching member is assembled to the connector assembly, each of the opposing arms is received in a corresponding first slot of the opposing supports, the arm capable of moving up and down within the first slot for latching and unlatching the connector assembly to a mating connector.

13. The connector assembly of claim 3, wherein the front housing comprises opposing minor side surfaces connecting the major top and bottom surfaces of the front housing, and wherein each arm of the latching member is disposed adjacent, and extends forwardly along, a corresponding minor side surface of the front housing.

14. The connector assembly of claim 13, wherein each arm of the latching member terminates in a latch for latching to a mating connector.

15. The connector assembly of claim 14, wherein an elbow joins the latch to the arm, the elbow turning the arm toward the minor side surface corresponding to the arm, such that a gap between the latch and the side surface is less than a gap between the arm and the side surface.

16. The connector assembly of claim 4, wherein the shield comprises opposing arms extending rearwardly from the shield on lateral sides of the unitary front housing, each arm defining an opening therein that engages a corresponding protrusion disposed on a lateral side of the corresponding support of the unitary front housing.

17. The connector assembly of claim 1, wherein the flexible termination member comprises a disc portion comprising a peripheral edge making solderless physical and electrical contact with the corresponding front pad of the circuit board.

18. The connector assembly of claim 1, wherein the flexible termination member of each contact is flexed by the front pad of the circuit board corresponding to the flexible termination member in a direction away from the front pad.

19. The connector assembly of claim 7 further comprising a latching member removably assembled to the unitary front and rear housings for latching the connector assembly to a mating connector.

20. The electrical contact of claim 8, wherein when the contact is assembled to a connector and the connector is assembled to a circuit board, the flexible termination member makes solderless physical and electrical contact with, and is deflected by, the pad of the circuit board.
